(19) United States
(12) Patent Application Publication
(10) Pub. No.: US 2007/0216227 A1
(43) Pub. Date: Sep. 20, 2007

(54) Vehicle electronic control unit

(75) Inventor: Hideharu Nagatomo, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/724,314

(22) Filed: Mar. 15, 2007

(30) Foreign Application Priority Data
Mar. 15, 2006 (JP) 2006-71188

(51) Int. Cl. H02G 3/00

(52) U.S. Cl. 307/10.1

(57) ABSTRACT

A vehicle electronic control unit includes a main control unit, a plurality of optional control units, sockets, and a connection unit. The main control unit performs common and essential functions for a vehicle. Each of the optional control units performs a different optional function for the vehicle based on a control signal received from the main control unit. The sockets are provided to at least one of the main control unit and the connection unit. Each of the optional control units is attachable to and detachable from any one of the sockets. The connection unit is electrically connected to the main control unit. When being attached to the sockets, the optional control units are electrically connected to the main control unit via the connection unit. Thus, the electronic control unit can be easily customized to suit individual needs and consequently can be standardized.

### CROSS REFERENCE TO RELATED APPLICATION

This application is based on and incorporates herein by reference Japanese Patent Application No. 2006-71188 filed on Mar. 15, 2006.

### FIELD OF THE INVENTION

The present invention relates to an electronic control unit for a vehicle.

### BACKGROUND OF THE INVENTION

A vehicle electronic control unit (ECU) disclosed in JP-A-2000-177510 includes a controller board and a main control unit premounted on the controller board. An integrated circuit (IC), a microcomputer, and peripheral parts are integrated in the main control unit so that the main control unit performs common and essential functions for controlling the vehicle. Optional control units for performing optional functions (e.g., automatic light control and remote door lock control) for a vehicle can be retrofitted to the controller board. Thus, the EUC disclosed in JP-A-2000-177510 can be customized to suit user's needs.

However, the optional control units are retrofitted to the controller board by a mounting process such as a soldering process. Therefore, it is relatively difficult to customize the EUC disclosed in JP-A-2000-177510 to suit the user's needs.

A fully specified ECU with every available optional control unit premounted on the controller board, for example, by soldering can meet the user's needs. However, the fully specified ECU requires a large manufacturing cost and many process steps as compared to an EUC to which optional control units are retrofitted according to the user's needs. Further, unused optional control units of the fully specified ECU must be disabled, for example, by disordering. Additional cost and steps are needed to disable the unused optional units.

### SUMMARY OF THE INVENTION

In view of the above-described problem, it is an object of the present invention to provide a vehicle electronic control unit that can be easily customized to suit individual needs and consequently can be standardized.

A vehicle electronic control unit includes a main control unit, a plurality of optional control units, sockets, and a connection unit. The main control unit performs common and essential functions for a vehicle. For example, the main control unit controls power supply to vehicle-mounted equipments and controls communication between the vehicle-mounted equipments. Each of the optional control units performs a different optional function for the vehicle based on a control signal received from the main control unit. For example, one optional control unit performs automatic light control and another optional control unit performs remote door lock control. The optional control units are available as options and mounted to the electronic control unit according to individual needs. The sockets are provided to at least one of the main control unit and the connection unit. Each of the optional control units is attachable to and detachable from any one of the sockets. The connection unit is electrically connected to the main control unit. When being attached to the sockets, the optional control units are electrically connected to the main control unit via the connection unit. In such an approach, the optional control units can be easily retrofitted to the electronic control unit without a mounting process such as a soldering process. Thus, the electronic control unit can be easily customized to suit the individual needs and consequently can be standardized.

### BRIEF DESCRIPTION OF THE DRAWINGS

The above and other objectives, features and advantages of the present invention will become more apparent from the following detailed description made with reference to the accompanying drawings. In the drawings:

FIG. 1 is a perspective side view of an electronic control unit according to an embodiment of the present invention;

FIG. 2 is a plan view of a main control unit of the electronic control unit of FIG. 1; and

FIGS. 3A and 3B are plan views of optional control units of the electronic control unit of FIG. 1.

### DETAILED DESCRIPTION OF THE PREFERRED EMBODIMENT

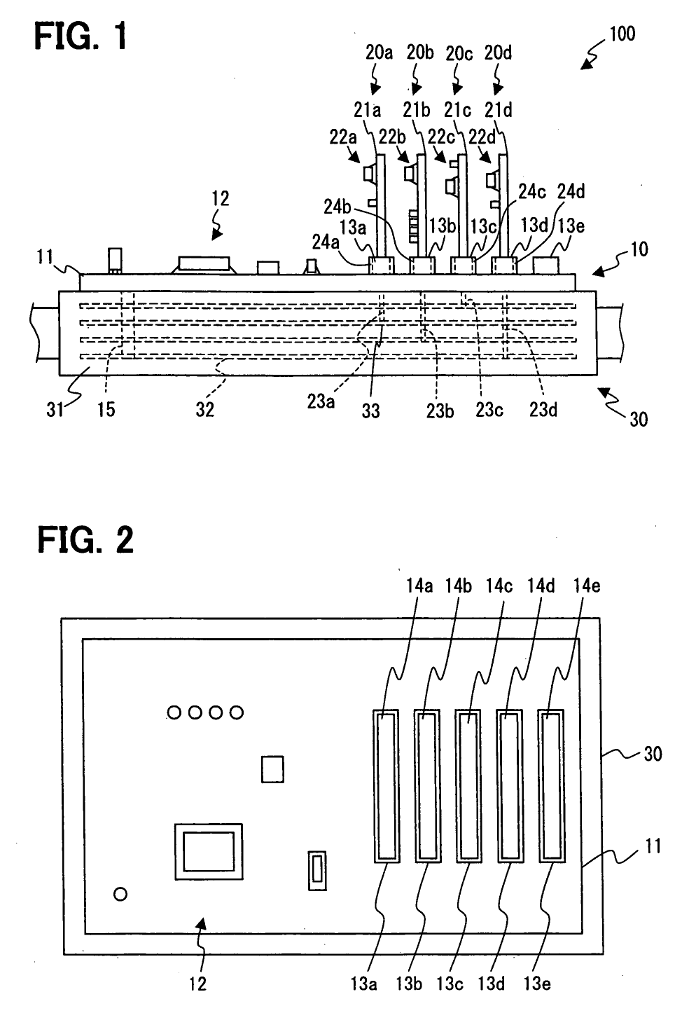

As shown in FIG. 1, a vehicle electronic control unit (ECU) 100 according to an embodiment of the present invention includes a main control unit 10, optional control units 20a-20d, and a junction block 30. The main control unit 10, the optional control units 20a-20d, and the junction block 30 are electrically connected to each other. The ECU 100 is housed in a protection case (not shown) and mounted to a vehicle.

As shown in FIGS. 1 and 2, the main control unit 10 includes a printed circuit board 11, a main control circuit 12, sockets 13a-13e with openings 14a-14e, respectively, and a male terminal 15.

The printed circuit board 11 includes a base substrate made of thermoplastic resin, thermoset resin, ceramics, glass-resin composite (e.g., glass cloth), or the like. The printed circuit board 11 is provided with conductive lands, wiring patterns connecting the lands, via holes connecting the wiring patterns. Electronic components such as a microcomputer, a power transistor, a chip resistor, a capacitor, and the like are soldered to the lands. Thus, the electronic components are electrically connected to each other through the wiring patterns and via holes so as to construct the main control circuit 12.

The sockets 13a-13e are attached to the printed circuit board 11 by an adhesive, a screw, or the like. All the openings 14a-14e of the sockets 13a-13e have the same shape. A hole (not shown) penetrating through the printed circuit board 11 is provided inside each of the sockets 13a-13e. Alternatively, the sockets 13a-13e may be attached to the junction block 30.

The male terminal 15 is electrically attached to the printed circuit board 11 by a solder or the like. The main control unit 10 is electrically connected to the junction block 30 via the male terminal 15 of the printed circuit board 11.

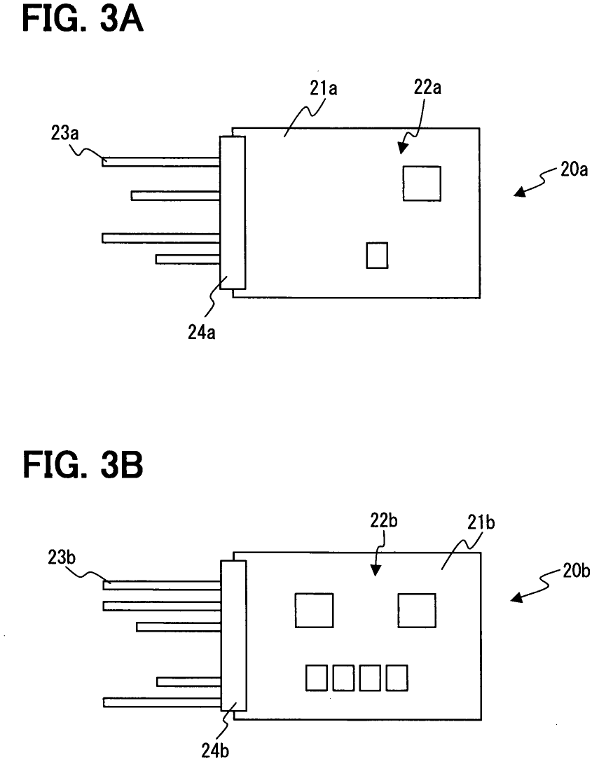

As shown in FIGS. 1, 3A, 3B, the optional control units 20a-20d includes printed circuit boards 21a-21d, optional control circuits 22a-22d, male terminals 23a-23d, and connector members 24a-24d, respectively. The optional control units 20a-20d perform different optional functions. For example, the optional control unit 20a performs automatic light control and the optional control unit 20b performs remote door lock control. The optional control units 20a-20d are available as options and mounted to the ECU 100 if necessary. The number of the optional control units 20a-20d mounted to the ECU 100 can vary according to individual needs. For example, while the optional control units 20a, 20b may be mounted to the ECU 100, the optional control units 20c, 20d may not be mounted to the ECU 100.

Each of the printed circuit boards 21a-21d of the optional control units 20a-20d includes a base substrate made of thermoplastic resin, thermoset resin, ceramics, glass-resin composite (e.g., glass cloth), or the like. Each of the printed circuit boards 21a-21d is provided with conductive lands, wiring patterns connecting the lands, via holes connecting the wiring patterns. Electronic components such as a microcomputer, a power transistor, a chip resistor, a capacitor, and the like are soldered to the lands. Thus, the electronic components are electrically connected to each other through the wiring patterns and via holes so as to construct each of the optional control circuits 22a-22d.

The male terminals 23a-23d of the optional control units 20a-20d are electrically attached to the printed circuit boards 21a-21d, respectively, for example, by a solder. As shown in FIGS. 1, 3A, 3B, the male terminals 23a-23d are different in number and length from each other, depending on the functions of the optional control circuits 22a-22d. The optional control units 20a-20d are electrically connected to the junction block 30 via the male terminals 23a-23d, respectively.

The connector members 24a-24d of the optional control units 20a-20d act as an interface to the main control unit 10. The optional control units 20a-20d are attached to the main control unit 10 by insetting the connector members 24a-24d into the openings 14a-14d of the sockets 13a-13d. The sockets 13a-13d suitably receives and holds the connector members 24a-24d so that the optional control units 20a-20d can not be accidentally detached from the main control unit 10 and can be intentionally detached from the main control unit 10, for example, by an user. As with the openings 14a-14d of the sockets 13a-13d, the connector members 24a-24d have the same shape. Therefore, each of the optional control units 20a-20d is attachable to and detachable from any one of the sockets 13a-13d.

The junction block 30 includes a housing 31 and a busbar 32 housed in the housing 31. As shown in FIG. 2, the busbar 32 includes a plurality of busbar members that are stacked with space therebetween. In the case of FIG. 1, the busbar 32 has four busbar members. Each of the busbar members has junction members 33 each of which has a conductive spring portion and is associated with a different one of the sockets 13a-13d. The junction members 33 are the same between the sockets 13a-13d.

When the optional control units 20a-20d are inserted in the sockets 13a-13d and the connector members 24a-24d are fitted into the openings 14a-14d, the male terminals 23a-23d of the optional control units 20a-20d are received by the junction members 33 due to spring force. Thus, the male terminals 23a-23d have electrical contacts with the busbar members of the busbar 32 so that the optional control units 20a-20d can be electrically connected to the junction block 30. The male terminal 15 of the main control unit 10 has an electrical contact with a junction member of the busbar 32 in the same manner as the male terminals 23a-23d. Thus, the main control unit 10 is electrically connected to the junction block 30. Therefore, each of the optional control units 20a-20d is electrically connected to the main control unit 10 via the junction block 30.

According to the embodiment, since the male terminals 23a-23d of the optional control units 20a-20d electrically contact with the busbar 32 of the junction block 30 by the spring force, the optional control units 20a-20d can be added to or removed from the junction block 30 without a mounting process such as a soldering process. Thus, the optional control units 20a-20d can be easily retrofitted to the ECU 100 so that the ECU 100 can be easily customized to the individual needs. Consequently, the ECU 100 can be standardized.

According to the embodiment, while the male terminals 23a-23d of the optional control units 20a-20d are different, for example, in number or length from each other, all the sockets 13a-13e (specifically, the openings 14a-14e) of the main control unit 10 have the same shape. Further, the junction members 33 are the same between the sockets 13a-13d. In such an approach, the optional control units 20a-20d can be correctly and electrically connected to the busbar 32, even when the optional control units 20a-20d are inserted in any sockets 13a-13e of the main control unit 10. Thus, the optional control units 20a-20d can perform the individual functions, even when the optional control units 20a-20d are inserted in any sockets 13a-13e of the main control unit 10. For example, it is assumed that the optional control unit 20a is designed to perform the automatic light control. The optional control unit 20a operates properly to perform the automatic light control, regardless of which of the sockets 13a-13e the optional control unit 20a is inserted in.

The ECU 100 operates as follows: The microcomputer of the main control circuit 12 of the main control unit 10 performs common and essential functions for a vehicle. For example, the microcomputer of the main control circuit 12 includes a power supply section for controlling power supply to vehicle-mounted equipments and a communication section for controlling communications between the vehicle-mounted equipments. Specifically, the microcomputer of the main control circuit 12 has a memory (e.g., ROM, RAM, or EEPROM) storing a control program. The microcomputer of the main control circuit 12 operates in accordance with the program so that the power supply section controls the power supply and the communication section controls the communications. Thus, the microcomputer of the main control circuit 12 performs the common and essential functions for the vehicle.

The microcomputer of the main control circuit 12 outputs a control signal to the optional control units 20a-20d through the busbar 32 of the junction block 30. The optional control units 20a-20d operate based on the control signal received from the main control unit 10. Each microcomputer of the optional control circuits 22a-22d of the optional control units 20a-20d has a memory (e.g., ROM, RAM, or EEPROM) storing a different control program and different identification information. In response to the control signal received from the main control unit 10, each microcomputer of the optional control circuits 22a-22d operates in accordance with the control program. Thus, the optional control units 20a-20d perform the different optional functions. As described above, for example, the optional control unit 20a performs the automatic light control and the optional control unit 20b performs remote door lock control.

The microcomputer of the main control circuit 12 of the main control unit 10 also outputs a request signal to the optional control units 20a-20d through the busbar 32 of the junction block 30. In response to the request signal, each of the optional control circuits 22a-22d of the optional control units 20a-20d returns the identification information to the main control circuit 12. The microcomputer of the main control circuit 12 determines based on the identification information which of the optional control units 20a-20d are connected to the junction block 30.

Each of the optional control units 20a-20d includes an abnormality detection section that outputs an abnormal signal to the main control unit 10 in the event of an abnormal condition. When receiving the abnormal signal, the main control unit 10 outputs a stop signal to the abnormal optional control units 20a-20d. In response to the stop signal, the abnormal optional control units 20a-20d stop operation. Thus, the abnormal optional control units 20a-20d can be prevented from affecting the main control unit 10.

(Modifications)

The embodiment described above may be modified in various ways. For example, while the male terminals 23a-23d may be the same regardless of the functions of the optional control units 20a-20d, the junction members 33 may be different between the sockets 13a-13e. In this case, there is a one to one correspondence between the optional control units 20a-20d and the sockets 13a-13d. Therefore, for example, the male terminal 23a may be correctly and electrically connected to the junction member 33, only when the optional control unit 20a is inserted in the socket 13a. Likewise, the male terminal 23b may be correctly and electrically connected to the junction member 33, only when the optional control unit 20b is inserted in the socket 13b.

Some of the male terminals 23a-23d may different from each other and the others of the male terminals 23a-23d may be the same as each other. Accordingly, some of the junction members 33 are the same between sockets 13a-13e and the others of the junction members 33 are different between the sockets 13a-13e. For example, it is assumed that the optional control units 20a, 20b are likely to mounted to the ECU 100 and the optional control units 20c, 20d are unlikely to mounted to the ECU 100. In this case, the male terminals 23a, 23b may different from each other and the junction members 33 may be the same between the sockets 13a, 13b. In contrast, the male terminals 23c, 23d may be the same as each other and the junction members 33 are different between the sockets 13c, 13d.

The number of the optional control units 20a-20d and the sockets 13a-13e can vary.

Such changes and modifications are to be understood as being within the scope of the present invention as defined by the appended claims.

What is claimed is:

1. An electrical control unit for a vehicle, comprising
a main control unit for performing a common function for the vehicle and for outputting a control signal;
a plurality of sockets;
a plurality of optional control units each of which is attachable to and detachable from any one of the plurality of sockets, each optional control unit performing a different optional function for the vehicle based on the control signal outputted from the main control unit; and
a connection unit for electrically connecting the main control unit and at least a first one of the plurality of optional control units, wherein
the at least a first one of the plurality of optional control units is attached to any one of the plurality of sockets.

2. The electrical control unit according to claim 1, wherein
the main control unit outputs a request signal to the plurality of optional control units,
each of the plurality of optional control units includes a memory for storing a different identification information, and
the at least a first one of the plurality of optional control units outputs the identification information to the main control unit in response to the request signal outputted from the main control unit.

3. The electrical control unit according to claim 1, wherein
each of the plurality of optional control units includes an abnormality detector for outputting an abnormal signal to the main control unit in the event of an abnormal condition.

4. The electrical control unit according to claim 3, wherein
the main control unit outputs a stop signal to at least a second one of the plurality of optional control units, the at least a second one of the plurality of optional control units outputting the abnormal signal to the main control unit, and
the at least a second one of the plurality of optional control units stops to perform the optional function in response to the stop signal.

5. The electrical control unit according to claim 1, wherein
the plurality of sockets are disposed to at least one of the main control unit and the connection unit.

6. The electrical control unit according to claim 1, wherein
each of the plurality of optional control units includes at least one male terminal,
the connection unit includes a busbar having a plurality of junction members each of which is electrically connectable to the male terminal and associated with a different one of the plurality of sockets, and
the male terminal of the at least a first one of the plurality of optional control units is connected to one of the plurality of junction members, so that the main control unit and the at least a first one of the plurality of optional control units are electrically connected to each other via the busbar of the connection unit.

7. The electrical control unit according to claim 6, wherein
the male terminal is different between the plurality of optional control units, depending on the optional function, and
the plurality of junction members are the same as each other between the plurality of sockets.

8. The electrical control unit according to claim 6, wherein
the male terminal is the same between the plurality of optional control units, regardless of the optional function,
the plurality of junction members are different from each other between the plurality of sockets.

9. The electrical control unit according to claim 6, wherein
the male terminal is different between a first potion of the plurality of optional control units and is the same between a second portion of the plurality of optional control units, and
the plurality of junction members are different from each other between a first portion of the plurality of sockets and the plurality of junction members are the same as each other between a second portion of the plurality of sockets.

10. The electrical control unit according to claim 1, wherein
the main control unit includes a power supply section for controlling power supply to equipments mounted to the vehicle.

11. The electrical control unit according to claim 1, wherein
the main control unit includes a communication section for controlling communications between equipments mounted to the vehicle.
